(19) United States
(12) Patent Application Publication
(10) Pub. No.: US 2026/0318497 A1
(43) Pub. Date: Oct. 15, 2026

(54) LAMP AND VEHICLE

(71) Applicants: Zhejiang ZEEKR Intelligent Technology Co., Ltd., Ningbo (CN); Zhejiang Geely Holding Group Co., Ltd., Hangzhou (CN)

(72) Inventors: Shuai ZHANG, Ningbo (CN); Chaojun CHEN, Ningbo (CN); Xianghui LIN, Ningbo (CN)

(73) Assignees: Zhejiang ZEEKR Intelligent Technology Co., Ltd., Ningbo (CN); Zhejiang Geely Holding Group Co., Ltd., Hangzhou (CN)

(21) Appl. No.: 19/691,670

(22) Filed: May 29, 2026

Related U.S. Application Data
(63) Continuation of application No. PCT/CN2025/080446, filed on Mar. 4, 2025.

(30) Foreign Application Priority Data
Mar. 6, 2024 (CN) 202420434543.3

(51) Int. Cl. F21S 43/19; F21S 43/14; F21S 43/15

(52) U.S. Cl. CPC F21S 43/19; F21S 43/14; F21S 43/15

(57) ABSTRACT

Disclosed are a lamp and a vehicle. The lamp includes: a first strip-shaped light source; a lens disposed on a side of the first strip-shaped light source; a bracket disposed on a side of the first strip-shaped light source away from the lens; a second strip-shaped light source disposed on the bracket, where the second strip-shaped light source is perpendicular to the first strip-shaped light source, and the second strip-shaped light source has at least two light-emitting modes; a power supply disposed on a side of the bracket away from the first strip-shaped light source and the second strip-shaped light source; a controller disposed on a side of the power supply away from the bracket; and an output port electrically connected to the power supply.

### CROSS-REFERENCE TO RELATED APPLICATIONS

The present application is a continuation of International Application No. PCT/CN2025/080446, filed on Mar. 4, 2025, which claims priority to Chinese Patent Application No. 202420434543.3, filed on Mar. 6, 2024, both of which are incorporated herein by reference in their entireties.

### TECHNICAL FIELD

The present disclosure relates to, but is not limited to, the field of vehicle accessory technologies, and in particular to a lamp and a vehicle.

### BACKGROUND

As an important accessory of a vehicle, a trunk lamp is disposed inside a trunk of the vehicle to provide lighting for the trunk of the vehicle, making it easier for a user to retrieve items from the trunk. However, the current trunk lamp only provides lighting for the trunk, resulting in a limited application scenario and use, which cannot meet the lighting needs of users in other scenarios, thereby impairing the user experience.

### SUMMARY

The following is a brief summary of subject matter described in detail herein. This summary is not intended to be limiting as to the scope of the claims.

The present disclosure provides a lamp, including: a first strip-shaped light source; a lens disposed on a side of the first strip-shaped light source; a bracket disposed on a side of the first strip-shaped light source away from the lens; a second strip-shaped light source disposed on the bracket, wherein the second strip-shaped light source is perpendicular to the first strip-shaped light source, and the second strip-shaped light source has at least two light-emitting modes; a power supply disposed on a side of the bracket away from the first strip-shaped light source and the second strip-shaped light source; a controller disposed on a side of the power supply away from the bracket and configured to control charging and discharging of the power supply; and an output port electrically connected to the power supply and configured to output a current.

In an embodiment of the present disclosure, the bracket is L-shaped, and the first strip-shaped light source and the second strip-shaped light source are respectively located on two sides of the L-shaped bracket.

In an embodiment of the present disclosure, a length of the second strip-shaped light source is greater than a length of the first strip-shaped light source.

In an embodiment of the present disclosure, the second strip-shaped light source includes two LEDs, one of the two LEDs emits light in one of the at least two light-emitting modes, and the two LEDs emit light alternately in another of the at least two light-emitting modes.

In an embodiment of the present disclosure, the lamp further includes a first housing disposed on a side of the lens away from the first strip-shaped light source.

In an embodiment of the present disclosure, the lamp further includes a second housing disposed on a side of the second strip-shaped light source away from the bracket.

In an embodiment of the present disclosure, the lamp further includes a third housing, and the third housing, the second housing and the first housing are arranged in an encircling configuration to form an outer casing of the lamp.

In an embodiment of the present disclosure, the first housing, the second housing, and the third housing are integrally provided.

In an embodiment of the present disclosure, a light transmittance of the first housing is greater than a light transmittance of the third housing, and a light transmittance of the second housing is greater than the light transmittance of the third housing.

In an embodiment of the present disclosure, the first housing and the second housing are light-transmissive components, and the third housing is an opaque component.

In an embodiment of the present disclosure, the lamp further includes a hanging structure disposed on the third housing.

In an embodiment of the present disclosure, the hanging structure includes: a strap; at least one hook configured to fix the strap to the lamp; and at least one rivet evenly distributed on the strap.

In an embodiment of the present disclosure, the bracket includes a thermally conductive material.

The present disclosure further provides a vehicle, including the above lamp as a vehicle-mounted trunk lamp.

Other aspects will be apparent upon reading and understanding the drawings and detailed description.

### BRIEF DESCRIPTION OF DRAWINGS

In order to explain the technical solution according to embodiments of the present disclosure more clearly, the drawings required in the description of the embodiments will be briefly described below. It is apparent that the drawings in the following description are only some embodiments of the present disclosure. For those skilled in the art, other drawings can be obtained based on these drawings without any creative work.

FIG. 1 is a schematic structural diagram of a lamp according to an embodiment of the present disclosure.

FIG. 2 is a schematic view of the lamp viewed from a side of a third housing shown in FIG. 1.

FIG. 3 is a schematic view of the lamp viewed from a side of a second housing shown in FIG. 1.

FIG. 4 is an exploded view of a lamp according to an embodiment of the present disclosure.

### DESCRIPTION OF REFERENCE SIGNS

11, first strip-shaped light source; 12, lens; 13, first housing; 14, bracket; 15, second strip-shaped light source; 16, second housing; 17, third housing; 18, power supply; 19, controller; 20, power supply indicator; 21, hanging structure; 211, strap; 212, hook; 213, rivet; 22, charging port; 23, output port; 24, first switch; 25, second switch; 26, third switch.

### DETAILED DESCRIPTION

Embodiments of the present disclosure are described below by way of specific examples, and those skilled in the art can easily understand other advantages and effects of the present disclosure from the content disclosed in this specification. The present disclosure may also be implemented or applied via other different specific embodiments, and various details in this specification may also be modified or changed based on different perspectives and applications without departing from the spirit of the present disclosure. It should be noted that the following embodiments and features in the embodiments may be combined with each other without conflict.

It should be noted that the drawings provided in the following embodiments are intended only to schematically illustrate the basic concept of the present disclosure, so that only components related to the present disclosure are show in the drawings, and are not drawn based on the number, shape and size of the components during actual implementation, the type, number and proportion of each component during actual implementation may be arbitrarily changed, and the layout of the components may also be more complex.

In the present disclosure, it should be noted that, the terms, such as “center”, “upper”, “lower”, “left”, “right”, “vertical”, “horizontal”, “inner”, “outer”, and the like, if used, indicate an orientation or positional relationship based on that shown in the accompanying drawings, which is merely for the convenience of describing the present disclosure and simplifying the description, and does not indicate or imply that the device or element referred to must have a specific orientation, be constructed and operated in a specific orientation. Therefore, the terms cannot be understood as a limitation to the present disclosure. In addition, the terms, such as “first”, “second”, and the like, if used, are merely used for descriptive and distinguishing purposes only, and cannot be understood as indicating or implying relative importance.

In view of the above disadvantages of the related art, an object of the present disclosure is to provide a lamp, such as a vehicle-mounted trunk lamp, and a vehicle, which can expand the application scenarios of the lamp, integrate multiple functions into a single lamp, and improve the user experience.

In order to solve the above technical problems, the present disclosure is implemented by the following technical solutions.

The present disclosure provides a lamp, which integrates multiple functions such as a trunk lamp, a flashlight, a camping lamp, an SOS emergency lamp, an ambient lamp, and a power bank/portable power supply, so as to realize versatility of a single lamp and expand application scenarios and uses of the lamp, thereby improving user experience.

In summary, the present disclosure provides a lamp and a vehicle, which integrates multiple functions such as a flashlight, a camping lamp, an SOS emergency lamp, a power bank/portable power supply, an ambient lamp, and the like, thereby integrating multiple functions into a single lamp, expanding application scenarios of the lamp, meeting lighting needs of users in different scenarios, and improving user experience.

However, it is not necessary that any implementation of the present disclosure achieves all the advantages described above simultaneously.

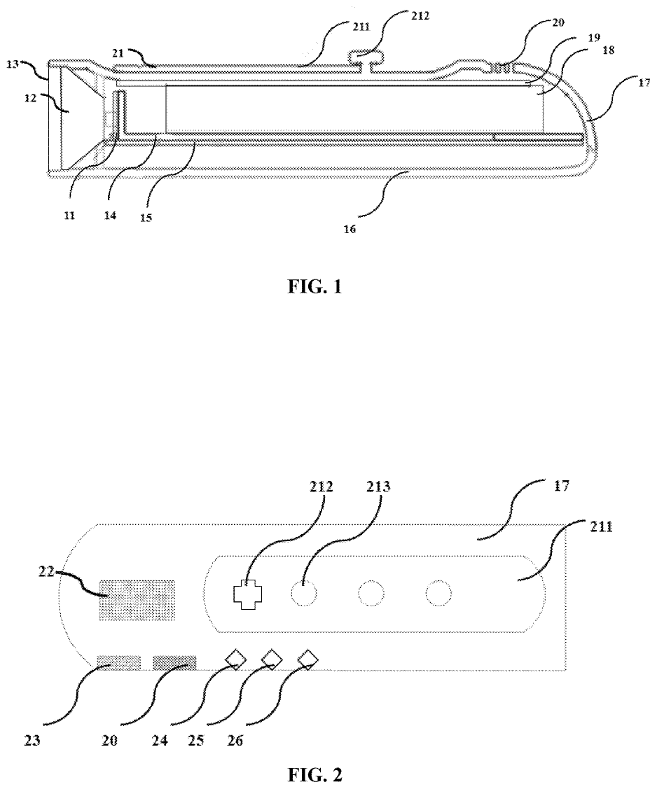

Referring to FIGS. 1 to 4, in an embodiment of the present disclosure, the lamp provided by the present disclosure includes, for example, a first strip-shaped light source 11, a lens 12, a first housing 13, a bracket 14, a second strip-shaped light source 15, a second housing 16, a third housing 17, a power supply 18, a controller 19, a power supply indicator 20, a hanging structure 21, a charging port 22, an output port 23, a first switch 24, a second switch 25, a third switch 26, and the like. The second strip-shaped light source 15 has at least two light-emitting modes. The first housing 13, in conjunction with the first strip-shaped light source 11 and the lens 12, can transmit light with high brightness, thereby enabling the lamp to function as the flashlight. Through the second strip-shaped light source 15, the light passing through the second housing 16 can produce different lighting effects, thereby enabling the lamp to function as the ambient lamp, the camping lamp, the SOS emergency lamp, or the like. The output port 23, in conjunction with the power supply 18 and the controller 19, can output current, thereby enabling the lamp to function as the power bank/portable power supply. Therefore, the lamp provided by the present disclosure can achieve multiple functions in a single lamp, greatly enriching its uses, thereby enhancing the user experience.

Referring to FIG. 1, in an embodiment of the present disclosure, the first strip-shaped light source 11 serves as a light source in the lamp to provide light. For example, at least one LED is disposed on the first strip-shaped light source 11, and the first strip-shaped light source 11 has at least one light-emitting mode to serve as a light source when the lamp functions as a flashlight, thereby meeting lighting needs of users in external environments with different brightness. In this embodiment, for example, two LEDs are disposed on the first strip-shaped light source 11, and the first strip-shaped light source 11 has, for example, two light-emitting modes. When the light of the external environment is weak or low-brightness illumination is desired for a user, one LED on the first strip-shaped light source 11 emits light, and the lamp provides low-brightness light. When the external environment is dark, there is no light, or high-brightness illumination is desired for a user, the two LEDs on the first strip-shaped light source 11 emit light simultaneously, and the lamp provides high-brightness light to meet the user's needs, such as object searching, path finding, and the like. In an embodiment of the present disclosure, the first strip-shaped light source 11 is, for example, an LED disposed on a circuit board. The material of the circuit board includes, for example, at least one of resin, fiberglass cloth, or an aluminum substrate. The circuit board has a length, for example, in a range from 20 mm to 30 mm (e.g., 25 mm). The circuit board has a width, for example, in a range from 5 mm to 15 mm (e.g., 10 mm). The circuit board has a height, for example, in a range from 0.5 mm to 1.5 mm (e.g., 1.1 mm).

Referring to FIG. 1, in an embodiment of the present disclosure, the lens 12 is disposed on a side of the first strip-shaped light source 11 for focusing the light emitted by the first strip-shaped light source 11, thereby increasing the intensity of the light. The lens 12 is, for example, a focusing lens, or a plano-convex lens, a positive meniscus lens (positive concave-convex lens), an aspherical lens, a diffractive lens, a reflective lens, or the like, to gather light emitted by the first strip-shaped light source 11. In this embodiment, the material of the lens 12 includes, for example, at least one of organic glass, polycarbonate, quartz glass, or the like, to improve the light transmittance of the lens 12.

Referring to FIG. 1, in an embodiment of the present disclosure, the first housing 13 is disposed on a side of the lens 12 away from the first strip-shaped light source 11 to provide shielding for the lens 12 and the first strip-shaped light source 11. The first housing 13 is formed, for example, by an injection molding process, or the like, and the material of the first housing 13 includes, for example, at least one of organic glass, polycarbonate, or the like, to improve impact resistance and light transmittance of the first housing 13. In this embodiment, the first housing 13 has a length, for example, in a range from 30 mm to 35 mm (e.g., 32 mm), the first housing 13 has a width, for example, in a range from 25 mm to 30 mm (e.g., 28 mm), and the first housing 13 has a height, for example, in a range from 5 mm to 15 mm (e.g., 10 mm), thereby protecting the lens 12 and the first strip-shaped light source 11.

Referring to FIG. 1, in an embodiment of the present disclosure, the bracket 14 is disposed on a side of the first strip-shaped light source 11 away from the lens 12, supporting the first strip-shaped light source 11 and the second strip-shaped light source 15 while dissipating heat generated by the first strip-shaped light source 11 and the second strip-shaped light source 15 due to light emission. The bracket 14 is, for example, L-shaped, and the first strip-shaped light source 11 and the second strip-shaped light source 15 are disposed on two sides of the L-shaped bracket 14. In this embodiment, the bracket 14 is made of a thermally conductive material, for example, at least one of aluminum or copper, to improve thermal conductivity of the bracket 14.

Referring to FIG. 1, in an embodiment of the present disclosure, the second strip-shaped light source 15 is disposed on the bracket 14, and the second strip-shaped light source 15 is perpendicular to the first strip-shaped light source 11 to serve as another light source in the lamp. The second strip-shaped light source 15 is, for example, an LED or the like disposed on a circuit board, the material of the circuit board includes, for example, at least one of resin, fiberglass cloth, or an aluminum substrate, the circuit board has a length, for example, in a range from 120 mm to 130 mm (e.g., 123 mm), the circuit board has a width, for example, in a range from 20 mm to 30 mm (e.g., 25 mm), and the circuit board has a height, for example, in a range from 0.5 mm to 1.5 mm (e.g., 1.1 mm). In an embodiment of the present disclosure, the length of the second strip-shaped light source 15 is, for example, greater than the length of the first strip-shaped light source 11, at least two LEDs are, for example, disposed on the second strip-shaped light source 15, and the second strip-shaped light source 15 has at least two light-emitting modes, serving as a light source when the lamp functions as the ambient lamp, the camping lamp, SOS emergency lamp, or the like.

Referring to FIG. 1, in this embodiment, for example, two LEDs are disposed on the second strip-shaped light source 15, the two LEDs emit, for example, white and red light, respectively, and the second strip-shaped light source 15 has, for example, two light-emitting modes. When one LED on the second strip-shaped light source 15 emits light, since the second strip-shaped light source 15 has a large length, the light emitted by the second strip-shaped light source 15 can cover a relatively large area near the trunk lamp, thereby functioning as the ambient lamp and the camping lamp. When the two LEDs on the second strip-shaped light source 15 emit light alternately, the lamp emits alternating red and white light, thereby functioning as the SOS emergency lamp.

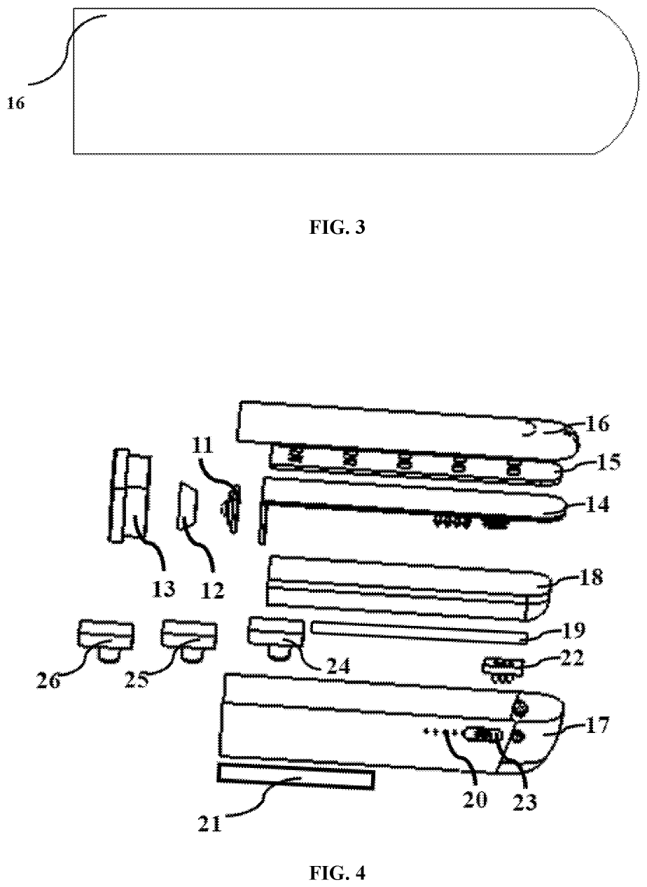

Referring to FIG. 1 and FIG. 3, in an embodiment of the present disclosure, the second housing 16 is disposed on a side of the second strip-shaped light source 15 away from the bracket 14, providing shielding for the second strip-shaped light source 15. The second housing 16 is formed, for example, by an injection molding process, or the like, and the material of the second housing 16 includes, for example, at least one of organic glass, polycarbonate, or the like, thereby improving impact resistance and light transmittance of the second housing 16. In this embodiment, the second housing 16 has a length, for example, in a range from 125 mm to 135 mm (e.g., 130 mm), the second housing 16 has a width, for example, in a range from 30 mm to 40 mm (e.g., 35 mm), and the second housing 16 has a height, for example, in a range from 5 mm to 15 mm (e.g., 5 mm), thereby protecting the second strip-shaped light source 15.

Referring to FIG. 1, in an embodiment of the present disclosure, the third housing 17, the second housing 16 and the first housing 13 are arranged in an encircling configuration to form an outer casing of the lamp, protecting the first strip-shaped light source 11, the lens 12, the bracket 14, the second strip-shaped light source 15, the power supply 18, the controller 19, and the like, inside the lamp, thereby improving the overall mechanical strength and impact resistance of the lamp. The material of the third housing 17 includes, for example, acrylonitrile-butadiene-styrene, or the like. The third housing 17 is formed, for example, by an injection molding process, or the like, and the third housing 17, the second housing 16, and the first housing 13 are, for example, integrally formed to improve the mechanical strength of the outer casing of the lamp. In an embodiment of the present disclosure, the light transmittance of the first housing 13 and the light transmittance of the second housing 16 are, for example, greater than that of the third housing 17. In another embodiment of the present disclosure, the first housing 13 and the second housing 16 are, for example, light-transmissive components, and the third housing 17 is, for example, an opaque component, so as to gather the light from the first strip-shaped light source 11 and the second strip-shaped light source 15 onto the first housing 13 and the second housing 16, avoid light scattering, and ensure the luminous intensity of the lamp.

Referring to FIG. 1, in an embodiment of the present disclosure, the power supply 18 is disposed on a side of the bracket 14 away from the first strip-shaped light source 11 and the second strip-shaped light source 15. The power supply 18 is, for example, a battery pack, or the like, to store electric energy and meet a power demand of a user.

Referring to FIG. 1, in an embodiment of the present disclosure, the controller 19 is disposed on a side of the power supply 18 away from the bracket 14 and is configured for controlling charging and discharging of the power supply 18. In an embodiment, the controller may be a printed circuit board assembly (PCBA).

Referring to FIGS. 1 and 2, in an embodiment of the present disclosure, the power supply indicator 20 is disposed on the third housing 17 and is configured to indicate the state of the power supply 18. When the power supply indicator 20 is flashing, the power supply 18 is being charged. When the power supply indicator 20 is steadily lit, the power supply 18 is fully charged.

Referring to FIGS. 1 and 2, in an embodiment of the present disclosure, the lamp further includes a hanging structure 21, and the hanging structure 21 is, for example, disposed on the third housing 17. By using the hanging structure 21, the lamp can be detachably connected to the trunk of the vehicle, and the lamp may be fixedly placed in an environment other than the vehicle based on the needs of the user, thereby implementing functions other than a vehicle-mounted trunk lamp. In an embodiment of the present disclosure, the hanging structure 21 includes, for example, a strap 211, at least one hook 212, at least one rivet 213, and the like. The strap 211 is, for example, disposed on the third housing 17, and the hook 212 and the rivet 213 are, for example, disposed on the strap 211. The hook 212 connects the strap 211 to the third housing 17 to prevent the strap 211 from detaching. The rivet 213 may be used to fix the lamp at a desired location. In this embodiment, the hanging structure 21 includes, for example, three rivets 213 and one hook 212, and the three rivets 213 are evenly distributed on the strap 211. The hook 212 is disposed on a side of the strap 211 close to the charging port 22 to connect the strap 211 and the third housing 17, preventing the strap 211 from detaching. The material of the strap 211 includes, for example, rubber, or the like. In an embodiment, the third housing is further provided with a protrusion that can engage with the rivet 213. After the strap 211 extends through the place to be fixed, the rivet on the strap may be snap-fitted with the protrusion, thereby fixing the lamp.

Referring to FIGS. 1 and 2, in an embodiment of the present disclosure, the charging port 22 is disposed on a side of the hanging structure 21 and is configured for connecting an external power source to charge the power supply 18. In this embodiment, the lamp further includes a waterproof charging plug that is movably connected to the charging port 22 to protect the charging port 22. The material of the charging waterproof plug includes, for example, rubber, or the like.

Referring to FIG. 1 to FIG. 2, in an embodiment of the present disclosure, the output port 23 is electrically connected to the power supply 18, is disposed on a side of the power supply indicator 20, and is configured to connect to an external device to charge the external device, thereby enabling the lamp to function as the power bank/portable power supply. In this embodiment, the lamp further includes a port waterproof plug, and the port waterproof plug is movably connected to the output port 23 to protect the output port 23. The port waterproof plug is made of, for example, rubber, or the like.

Referring to FIG. 1 and FIG. 2, in an embodiment of the present disclosure, the lamp further includes a first switch 24, a second switch 25 and a third switch 26, the first switch 24 is, for example, disposed on a side of the power supply indicator 20 away from the output port 23, the second switch 25 is, for example, disposed on a side of the first switch 24 away from the power supply indicator 20, and the third switch 26 is, for example, disposed on a side of the second switch 25 away from the first switch 24. The switches are used for controlling the switching of the light-emitting modes of the lamp. When the first switch 24 is turned on, the lamp functions as the flashlight, and the light emitted by the first strip-shaped light source 11 passes through the first housing 13 to meet the lighting needs. When the second switch 25 is turned on, the lamp functions as the camping lamp and the ambient lamp, and the second strip-shaped light source 15 emits single color light to meet user needs. When the third switch 26 is turned on, the lamp functions as the SOS emergency lamp, and the second strip-shaped light source 15 alternately flashes red and white light as a distress signal.

Referring to FIG. 1 to FIG. 4, the present disclosure further provides a vehicle, the vehicle includes the above-mentioned lamp as a vehicle-mounted trunk lamp, the lamp is movably connected to the vehicle trunk, and the lamp can also be used as the ambient lamp, the camping lamp, the SOS emergency lamp and the power bank/portable power supply while providing lighting for the vehicle trunk, so as to meet the user needs in different scenarios.

In some embodiments, the vehicle-mounted trunk lamp may be controlled by an in-vehicle infotainment system without directly operating the first switch, the second switch, or the third switch. In some embodiments, when the vehicle-mounted trunk lamp is in the vehicle, it can be directly controlled by the in-vehicle infotainment system without directly operating the first switch, the second switch or the third switch; when the vehicle-mounted trunk lamp is not in the vehicle, that is, when the vehicle-mounted trunk lamp is taken out from the vehicle, it cannot be directly controlled by the in-vehicle infotainment system.

In summary, the present disclosure provides a lamp and a vehicle. The first housing, in conjunction with the first strip-shaped light source and the lens, can transmit high-brightness light, thereby enabling the lamp to function as the flashlight. Through the second strip-shaped light source, the second housing can emit light with a plurality of light emitting effects, thereby enabling the lamp to function as the ambient lamp, the camping lamp, or the SOS emergency lamp. The output port, in conjunction with the power supply and the controller, can output current, thereby enabling the lamp to function as the power bank/portable power supply. Therefore, the lamp provided by the present disclosure can integrate multiple functions into a single lamp, expanding the application scenarios and use of the trunk lamp, thereby enhancing the user experience.

The above embodiments are merely illustrative of the principles and effects of the present disclosure, and are not intended to limit the present disclosure. Any person skilled in the art can modify or change the above embodiments without departing from the spirit and scope of the present disclosure. Therefore, all equivalent modifications or changes made by those skilled in the art without departing from the spirit and technical concepts disclosed in the present disclosure should still be covered by claims of the present disclosure.

1. A lamp, comprising:
a first strip-shaped light source;
a lens disposed on a side of the first strip-shaped light source;
a bracket disposed on a side of the first strip-shaped light source away from the lens;
a second strip-shaped light source disposed on the bracket, wherein the second strip-shaped light source is perpendicular to the first strip-shaped light source, and the second strip-shaped light source has at least two light-emitting modes;
a power supply disposed on a side of the bracket away from the first strip-shaped light source and the second strip-shaped light source;
a controller disposed on a side of the power supply away from the bracket and configured to control charging and discharging of the power supply; and
an output port, electrically connected to the power supply and configured to output a current.

2. The lamp according to claim 1, wherein the bracket is L-shaped, and the first strip-shaped light source and the second strip-shaped light source are respectively located on two sides of the L-shaped bracket.

3. The lamp according to claim 1, wherein a length of the second strip-shaped light source is greater than a length of the first strip-shaped light source.

4. The lamp according to claim 1, wherein the second strip-shaped light source comprises two LEDs, one of the two LEDs emits light in one of the at least two light-emitting modes, and the two LEDs emit light alternately in another of the at least two light-emitting modes.

5. The lamp according to claim 1, further comprising a first housing disposed on a side of the lens away from the first strip-shaped light source.

6. The lamp according to claim 5, further comprising a second housing disposed on a side of the second strip-shaped light source away from the bracket.

7. The lamp according to claim 6, further comprising a third housing,
wherein the third housing, the second housing, and the first housing are arranged in an encircling configuration to form an outer casing of the lamp.

8. The lamp according to claim 7, wherein the first housing, the second housing, and the third housing are integrally provided.

9. The lamp according to claim 7, wherein a light transmittance of the first housing is greater than a light transmittance of the third housing, and a light transmittance of the second housing is greater than the light transmittance of the third housing.

10. The lamp according to claim 7, wherein the first housing and the second housing are light-transmissive components, and the third housing is an opaque component.

11. The lamp according to claim 7, further comprising a hanging structure disposed on the third housing.

12. The lamp according to claim 11, wherein the hanging structure comprises:
a strap,
at least one hook configured to fix the strap to the lamp, and
at least one rivet evenly distributed on the strap.

13. The lamp according to claim 1, wherein the bracket comprises a thermally conductive material.

14. A vehicle, comprising a lamp, wherein the lamp comprises:
a first strip-shaped light source;
a lens disposed on a side of the first strip-shaped light source;
a bracket disposed on a side of the first strip-shaped light source away from the lens;
a second strip-shaped light source disposed on the bracket, wherein the second strip-shaped light source is perpendicular to the first strip-shaped light source, and the second strip-shaped light source has at least two light-emitting modes;
a power supply disposed on a side of the bracket away from the first strip-shaped light source and the second strip-shaped light source;
a controller disposed on a side of the power supply away from the bracket and configured to control charging and discharging of the power supply; and
an output port, electrically connected to the power supply and configured to output a current,
wherein the lamp serves as a vehicle-mounted trunk lamp.

15. The vehicle according to claim 14, wherein the bracket is L-shaped, and the first strip-shaped light source and the second strip-shaped light source are respectively located on two sides of the L-shaped bracket.

16. The vehicle according to claim 14, wherein a length of the second strip-shaped light source is greater than a length of the first strip-shaped light source.

17. The vehicle according to claim 14, wherein the second strip-shaped light source comprises two LEDs, one of the two LEDs emits light in one of the at least two light-emitting modes, and the two LEDs emit light alternately in another of the at least two light-emitting modes.

18. The vehicle according to claim 14, wherein the lamp further comprises a first housing disposed on a side of the lens away from the first strip-shaped light source.

19. The vehicle according to claim 18, wherein the lamp further comprises a second housing disposed on a side of the second strip-shaped light source away from the bracket.

20. The vehicle according to claim 19, wherein the lamp further comprises a third housing,
wherein the third housing, the second housing, and the first housing are arranged in an encircling configuration to form an outer casing of the lamp.
